(19) United States
(12) Patent Application Publication
(10) Pub. No.: US 2026/0340925 A1
(43) Pub. Date: Oct. 29, 2026

(54) Efficient Neural Radiance Field Rendering

(71) Applicant: Google LLC, Mountain View, CA (US)

(72) Inventors: Lars Peter Johannes Hedman, London (GB); Andrea Tagliasacchi, Victoria (CA); Zhiqin Chen, Burnaby (CA); Thomas Allen Funkhouser, Menlo Park, CA (US)

(21) Appl. No.: 18/998,858

(22) PCT Filed: Jul. 20, 2023
(86) PCT No.: PCT/US2023/028188

§ 371 Date: Jan. 27, 2025

Related U.S. Application Data
(60) Provisional application No. 63/392,060, filed on Jul. 25, 2022.

(51) Int. Cl. G06T 15/00; G06N 3/08; G06T 15/04; G06T 15/20

(52) U.S. Cl. CPC G06T 15/005; G06N 3/08; G06T 15/04; G06T 15/20; G06T 2210/52

(57) ABSTRACT

Provided is a new neural radiance field (NeRF) representation based on textured polygons that can synthesize novel images efficiently with standard rendering pipelines. The NeRF is represented as a set of polygons with textures representing binary opacities and feature vectors. Traditional rendering of the polygons with a mesh rasterizer (e g., including use of a z-buffer) yields an image with features at every pixel, which are interpreted by a small, view-dependent MLP running in a fragment shader to produce a final pixel color. This approach enables NeRFs to be rendered with the traditional polygon rasterization pipeline, which provides massive pixel-level parallelism, achieving interactive frame rates on a wide range of compute platforms, including mobile phones.

### PRIORITY CLAIM

The present application is based on and claims priority to U.S. Provisional Application 63/392,060 having a filing date of Jul. 25, 2022, which is incorporated by reference herein.

### FIELD

The present disclosure relates generally to machine learning. More particularly, the present disclosure relates to systems and methods that leverage polygon rasterization pipelines for efficient neural field rendering, for example, on mobile architectures.

### BACKGROUND

Neural Radiance Fields (NeRF) have become a popular representation for novel view synthesis of 3D scenes. NeRF models represent a scene using a multilayer perceptron (MLP) that evaluates a 5D implicit function estimating the density and radiance emanating from any position in any direction, which can be used in a volumetric rendering framework to produce novel images. See Mildenhall et al., Nerf: Representing scenes as neural radiance fields for view synthesis. In ECCV, 2020. NeRF representations optimized to minimize multi-view color consistency losses for a set of posed photographs have demonstrated remarkable ability to reproduce fine image details for novel views.

However, one of the main impediments to wide-spread adoption of NeRF is that it requires specialized rendering algorithms that are poor match for commonly available hardware. In particular, traditional NeRF implementations use a volumetric rendering algorithm that evaluates a large MLP at hundreds of sample positions along the ray for each pixel in order to estimate and integrate density and radiance. This rendering process is far too slow for interactive visualization.

### SUMMARY

Aspects and advantages of embodiments of the present disclosure will be set forth in part in the following description, or can be learned from the description, or can be learned through practice of the embodiments.

One example aspect is directed to a computing device for performing efficient image rendering. The computing device comprises one or more processors. The computing device comprises one or more non-transitory computer-readable media that collectively store a mesh model of a scene and one or more texture images comprising learned feature and opacity data for the mesh model. The computing device comprises a rendering pipeline configured to generate a rendered image of the scene from a specified camera pose. The rendering pipeline comprises a mesh rasterizer configured to generate a feature image comprising a plurality of fragments, wherein each fragment corresponds to at least a portion of the mesh model that is visible from the specified camera pose, and wherein, for each fragment, the feature image comprises the respective learned feature and opacity data provided by the one or more texture images for the corresponding portion of the mesh model. The rendering pipeline comprises a machine-learned neural fragment shader configured to process the specified camera pose and the respective learned feature and opacity data for each fragment of the feature image to output a respective output color for each fragment for use in the rendered image.

Another example aspect is directed to a computer-implemented method for generating a rendered image of a scene from a specified camera pose. The method comprises obtaining, by a computing system comprising one or more computing devices, a mesh model of the scene and one or more texture images comprising learned feature and opacity data for the mesh model. The method comprises generating, by the computing system, a feature image comprising a plurality of fragments, wherein each fragment corresponds to at least a portion of the mesh model that is visible from the specified camera pose, and wherein, for each fragment, the feature image comprises the respective learned feature and opacity data provided by the one or more texture images for the corresponding portion of the mesh model. The method comprises processing, by the computing system using a machine-learned neural fragment shader, the specified camera pose and the respective learned feature and opacity data for each fragment of the feature image to output a respective output color for each fragment. The method comprises providing, by the computing system, the rendered image of the scene as an output, the rendered image of the scene having the respective output colors provided by the machine-learned neural fragment shader.

Another example aspect is directed to one or more non-transitory computer-readable media that collectively store instructions that, when executed by one or more processors, cause the one or more processors to perform operations for each of one or more training iterations. The operations comprise obtaining a training image that depicts a scene from a camera pose. The operations comprise processing a plurality of positions associated with a learnable mesh model with a feature field model to generate feature data and with an opacity field model to generate opacity data. The operations comprise processing the feature data and the camera pose with a neural fragment shader to generate color data. The operations comprise performing alpha-compositing of the color data and opacity data based on the camera pose to generate one or more output colors for a rendered image. The operations comprise evaluating a loss function that compares the rendered image the training image to determine a loss. The operations comprise modifying one or more parameter values for one or more of the following based on the loss: the learnable mesh model, the feature field model, the opacity field model, and the neural fragment shader.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example rendering pipeline for efficient neural radiance field rendering according to example embodiments of the present disclosure.

FIG. 2 depicts a block diagram of an example training approach for efficient neural radiance field rendering according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed a new neural radiance field (NeRF) representation based on textured polygons that can synthesize novel images efficiently with standard rendering pipelines. In particular, a NeRF can be represented as a set of polygons with textures representing binary opacities and feature vectors. Traditional rendering of the polygons with a mesh rasterizer (e.g., including use of a z-buffer) yields a feature image with features at every fragment (e.g., pixel). The features of the feature image can be interpreted by a neural fragment shader (e.g., small, view-dependent MLP running in a fragment shader) to produce a final pixel color. This approach enables NeRFs to be rendered with the traditional polygon rasterization pipeline, which provides massive pixel-level parallelism, achieving interactive frame rates on a wide range of compute platforms, including mobile phones or other mobile or embedded architectures.

More particularly, NeRFs have demonstrated amazing ability to synthesize images of 3D scenes from novel views. However, they rely upon specialized volumetric rendering algorithms based on ray marching that are mismatched to the capabilities of widely deployed graphics hardware. Therefore, typical NeRFs cannot be practically rendered on ubiquitous mobile architectures such as smartphones.

While approaches that pre-compute and “bake” NeRFs into a sparse 3D voxel grid may increase the rendering speed of NeRF, these approaches still rely upon ray marching through a sparse voxel grid to produce the features for each pixel, and thus do not fully utilize the parallelism available in commodity graphics processing units (GPUs). In addition, these approaches require a significant amount of GPU memory to store volumetric textures, which also prohibit these approaches from running on common mobile devices.

In view of these issues, the present disclosure introduces MobileNeRF, a NeRF that can run on a variety of common mobile devices in real time. The NeRF can be represented by a mesh model and one or more texture image(s). For example, the mesh model can include a set of polygons with associated textures, where the polygons roughly follow the surface of the scene, and the texture image(s) store opacity and feature vectors learned for the polygons during training.

To render an image, example implementations can utilize a polygon rasterization pipeline framework. For example, the rendering pipeline can include a mesh rasterizer and a neural fragment shader. The mesh rasterizer can perform z-buffering to produce a feature vector for each fragment (e.g., pixel) of an image to be rendered. The feature vector for each fragment can then be processed by the neural fragment shader (e.g., a lightweight MLP running in a GLSL fragment shader) to produce the output color.

Some example implementations of this rendering pipeline do not sample rays or sort polygons in depth order, and thus can model only binary opacities. However, the rendering pipeline can take full advantage of the parallelism provided by z-buffers and fragment shaders in modern graphics hardware, and thus is 10× faster than current state of the art approaches with the same output quality on standard test scenes.

Moreover, the MobileNeRF approach described herein requires only a standard polygon rendering pipeline framework, which can be implemented and accelerated on virtually every computing platform, and thus it runs on mobile phones and other devices previously unable to support NeRF visualization at interactive rates.

Thus, the present disclosure provides a number of technical effects and benefits. As one example, the proposed models and associated rendering approaches are 10× faster than the current state-of-the-art with the same output quality.

As another example technical effect and benefit, the proposed techniques consume less memory by storing surface textures instead of volumetric textures, enabling the proposed method to run on integrated GPUs with significantly less memory and power;

As yet another example technical effect and benefit, the proposed techniques can be implemented to runs on a web browser and can be compatible with an enormous number and variety of devices. For example, the viewer can be written in HTML with three.js, which is executable by a large number of devices worldwide.

As yet another example technical effect and benefit, the proposed techniques allow real-time manipulation of the reconstructed objects/scenes, as they are simple triangle meshes.

With reference now to the Figures, example embodiments of the present disclosure will be discussed in further detail.

### Example Rendering Pipeline

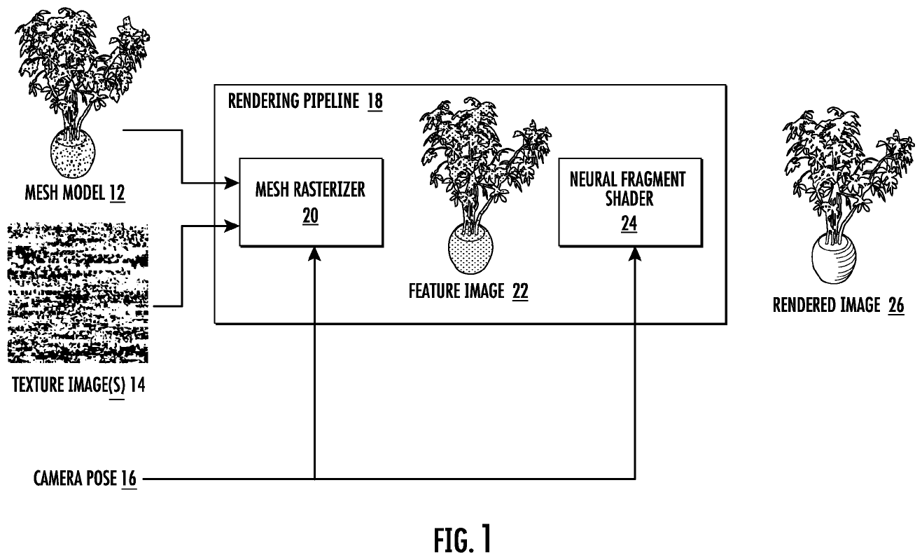

FIG. 1 depicts a block diagram of an example rendering pipeline for efficient neural radiance field rendering according to example embodiments of the present disclosure. Specifically, FIG. 1 shows a rendering pipeline 18 configured to generate a rendered image 26 of a scene when provided with the following rendering assets/information: a mesh model 12 of the scene, one or more texture images 14 including learned feature and opacity data for the mesh model 12, and a camera pose 16 from which the rendered image 26 is to be viewed/rendered.

The rendering pipeline 18 includes a mesh rasterizer 20 and a neural fragment shader 24. The mesh rasterizer 20 is configured to generate a feature image 22 including a plurality of fragments (e.g., pixels). Each fragment in the feature image 22 can correspond to at least a portion (e.g., polygon) of the mesh model 12 that is visible from the specified camera pose 16. Further, for each fragment, the feature image 22 includes the respective learned feature and opacity data provided by the one or more texture images for the corresponding portion (e.g., polygon) of the mesh model.

The neural fragment shader 24 is configured to process the specified camera pose 16 and the respective learned feature and opacity data for each fragment of the feature image 22 to output a respective output color for each fragment for use in the rendered image 26. That is, for each fragment (e.g., pixel) of the feature image 22, the neural fragment shader 24 can provide an output color and the rendered image 26 can be generated using the output colors.

In some implementations, the learned feature and opacity data stored in the texture image(s) 14 includes data that was output by one or more machine-learned neural radiance field models trained on training images that depict the scene. In some implementations, the machine-learned neural fragment shader 24 was jointly trained with the one or more machine-learned neural radiance field models. In some implementations, the one or more machine-learned neural radiance field models include a feature field model configured to process a position to generate feature data for the position; and an opacity field model configured to process the position to generate opacity data for the position. In some implementations, the mesh model 12 includes only polygons that are visible from one or more training images of the scene. Limiting the mesh model 12 to polygons that are visible from one or more training images can improve the quality of the mesh model 12 (e.g., by reducing errant or hallucinated scene structures that fail to match the semantics of the scene).

Referring still to FIG. 1, in some implementations, the feature image 22 is generated at a first resolution and the rendering pipeline 18 can be configured to downsample the feature image 22 to a second, smaller resolution prior to executing the machine-learned neural fragment shader 24 on the feature image 22. For example, the second resolution can be one-half of the first resolution. Super-sampling the feature image 22 followed by subsampling prior to application of the shader 24 can result in averaging of feature and opacity information contained in the super-sampled feature image 22. The averaging of feature and opacity information can provide benefits such as improved anti-aliasing in the rendered image 26.

According to an aspect of the present disclosure, the rendering pipeline 18 can be highly similar in terms of framework and execution to existing mesh model rendering pipelines. Therefore, the rendering pipeline 18 can be executed on a large number of common computer devices such as a smartphone, a mobile device (e.g., tablet, smartwatch, home assistant device, etc.), or an embedded device (e.g., in-board vehicle computing device, home appliance, Internet of Things devices, etc.). For example, in some implementations, the mesh rasterizer and the machine-learned neural fragment shader can be executed using one or more graphics processing units and/or other accelerated hardware which is optimized for image rendering.

In some implementations, to achieve compatibility with these existing rendering frameworks, the rendering pipeline 18 and rendering assets such as the mesh model 12 and the texture image(s) 14 can be defined in, stored as, or otherwise executed using various common file types. As examples, in some implementations, the mesh model 12 can be stored as an OBJ file; the one or more texture images 14 can be stored as one or more Portable Network Graphics (PNG) files; and/or weights of the machine-learned neural fragment shader 24 can be stored in a JavaScript Object Notation (JSON) file. As another example, in some implementations, the rendering pipeline 18 can be defined in, stored as, or otherwise executed using HyperText Markup Language (HTML). As another example, in some implementations, the neural fragment shader 24 can be defined in, stored as, or otherwise executed using OpenGL Shading Language (GLSL).

### Example Training Approach

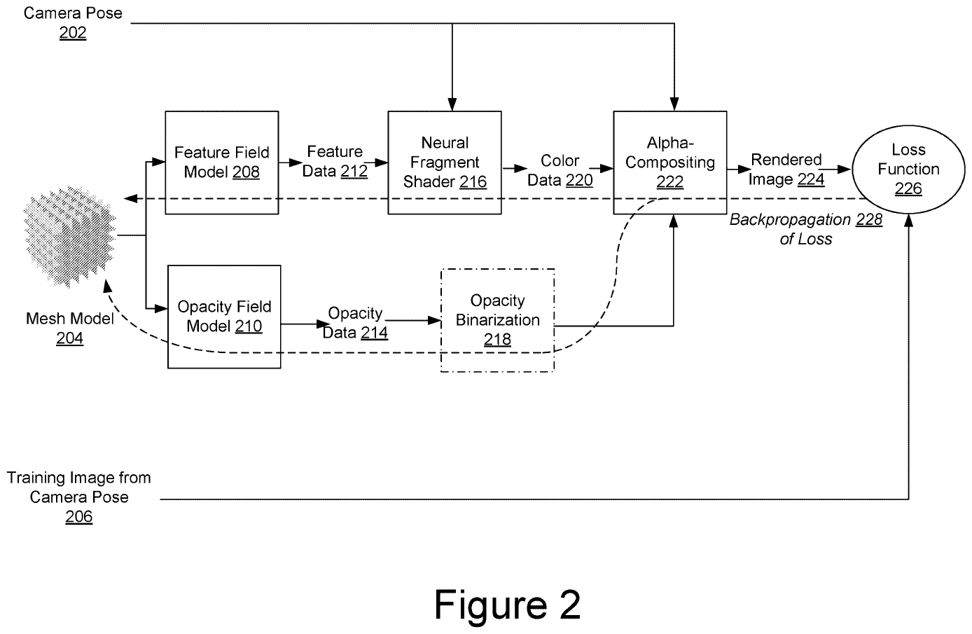

FIG. 2 depicts a block diagram of an example training approach for efficient neural radiance field rendering according to example embodiments of the present disclosure. The process shown in FIG. 2 can be performed for each of a number of training images that depict a scene. In some implementations, training can occur in multiple stages with each stage containing different permutations of the operations shown in FIG. 2 (and/or other operations).

Specifically, a computing system can obtain a training image 206 that depicts a scene from a camera pose 202. The computing system can process a plurality of positions associated with a learnable mesh model 204 with a feature field model 208 to generate feature data 212 and with an opacity field model 210 to generate opacity data 214. As examples, the feature field model 208 and the opacity field model 210 can be neural radiance field models (e.g., implemented using relatively larger MLPs).

The computing system can process the feature data 212 and the camera pose 202 with a neural fragment shader (e.g., implemented using a relatively smaller MLP) to generate color data 220. The computing system can perform alpha-compositing 222 of the color data 220 and opacity data 214 based on the camera pose 202 to generate one or more output colors for a rendered image 224.

The computing system can evaluate a loss function 226 that compares the rendered image 224 with the training image 206 to determine a loss. For example, the loss function 226 can be a mean squared error over pixel colors.

The computing system can modify one or more parameter values for one or more of the following based on the loss: the learnable mesh model 204, the feature field model 208, the opacity field model 210, and the neural fragment shader 216. For example, the loss and loss function 226 can be backpropagated 228 through the models as shown by the dashed lines in FIG. 2.

In some implementations, for at least one of the one or more training iterations, the computing system can binarize 218 the opacity data prior to performing the alpha-compositing 222. For example, in some implementations, the training can be performed without binarization 218 at a first stage (i.e., continuous opacity), while training can be performed with the binarization 218 at a second stage. In some implementations, the second stage can include training with both binarization 218 and also continuous opacity. In some implementations, the loss can be backpropagated through the opacity binarization 218 using straight-through estimation.

In some implementations, the alpha-compositing 222 can occur on the feature data 212 and the opacity data 214 before application of the neural fragment shader 216 (not shown). The neural fragment shader 216 can then be applied to the output of the alpha-compositing 222 on the feature data 212.

In some implementations, for at least one of the one or more training iterations, the computing system can subsample the feature data 212 prior to processing the feature data 212 and the camera pose 202 with the neural fragment shader 216 to generate the color data 220.

In some implementations, after the training iterations, the computing system can bake the feature data 212 and the opacity data 214 respectively output by the feature field model 208 and the opacity field model 210 into one or more texture images (not shown). For example, for all positions (e.g., polygons) of the mesh model 204, the feature field model 208 and the opacity field model 210 can be evaluated and their respective outputs can be stored in the one or more texture images for use during later rendering.

As another example, in some implementations, after the one or more training iterations, any portions (e.g., polygons) of the mesh model that are not-visible in any of the plurality of training images of the scene can be pruned. This can improve the quality of and reduce the memory requirements for the mesh model 204. In some implementations, the learnable mesh model 204 can be or include a grid mesh. Modifying one or more parameter values of the learnable mesh model 204 can include updating vertex locations of the grid mesh while holding a topology of the grid mesh fixed.

### EXAMPLE IMPLEMENTATIONS

This section describes example implementations of the generalized framework described herein.

Given a collection of (calibrated) images, some example implementations seek to optimize a representation for efficient novel-view synthesis. One example proposed representation includes a polygonal mesh whose texture maps store features and opacity. At rendering time, given a camera pose, some example implementations adopt a two-stage deferred rendering process:
Rendering Stage 1—some example implementations rasterize the mesh to screen space and construct a feature image, e.g., some example implementations create a deferred rendering buffer in GPU memory;
Rendering Stage 2—some example implementations convert these features into a color image via a (neural) deferred renderer running in a fragment shader, e.g., a small MLP, which receives a feature vector and view direction and outputs a pixel color.

One example proposed representation is built in three training stages, gradually moving from a classical NeRF-like continuous representation towards a discrete one:
Training Stage 1 (stage1)—Some example implementations train a NeRF-like model with continuous opacity, where volume rendering quadrature points are derived from the polygonal mesh;
Training Stage 2 (stage2)—Some example implementations binarize the opacities, as while classical rasterization can easily discard fragments, they cannot elegantly deal with semi-transparent fragments.
Training Stage 3 (stage3)—Some example implementations extract a sparse polygonal mesh, bake opacities and features into texture maps, and store the weights of the neural deferred shader.

As examples, the mesh can be stored as an OBJ file, the texture maps in PNGs, and the deferred shader weights in a (small) JSON file. As some example implementations employ the standard GPU rasterization pipeline, one example proposed real-time renderer is simply an HTML webpage.

As representing continuous signals with discrete representations can introduce aliasing, some example implementations also include a simple, yet computationally efficient, anti-aliasing solution based on super-sampling (antialiasing).

### Example Techniques for Continuous Training (Training Stage 1)

One example proposed training setup consists of a polygonal mesh [symbol] =( [symbol] , [symbol] ) and three learnable models such as, for example, MLPs. The mesh topology [symbol] is fixed, but the vertex locations [symbol] and MLPs are optimized, similarly to NeRF, in an auto-decoding fashion by minimizing the mean squared error between predicted colors and ground truth colors of the pixels in the training images:

$${\text{?}}_{C} = {\text{?}}_{r} {‖ C ( r ) - {C}_{gt} ( R ) ‖}_{2}^{2} . \qquad ( 1 )$$

where the predicted color C(·) is obtained by alpha-compositing the radiance cₖ along a ray r(t)=o+td, at the (depth sorted) quadrature points

$$\text{?} = {\{ {t}_{k} \}}_{k = 1}^{K} :$$

$$C ( r ) = {\sum }_{k = 1}^{K} {T}_{k} {α}_{k} {c}_{k} {T}_{k} = {\prod }_{l = 1}^{k - 1} ( 1 - {α}_{l} ) \qquad ( 2 )$$

where opacity αₖ and the view-dependent radiance cₖ are given by evaluating the MLPs at position pₖ=r(tₖ):

αₖ= [symbol] (p_{K}; [symbol] ) [symbol] : [symbol] ³→[0,1] (3)

fₖ= [symbol] (pₖ; [symbol] ) [symbol] : [symbol] ³→[0,1]⁸ (4)

cₖ= [symbol] (fₖ,d; [symbol] ) [symbol] : [0,1]⁸×[−1,1]³→[0,1]³ (5)

The small network [symbol] is one example proposed deferred neural shader, which outputs the color of each fragment given the fragment feature and viewing direction. Finally, note that (2) does not perform compositing with volumetric density, but rather with opacity [see, e.g., Eq.8].

### Example Polygonal Mesh

Without loss of generality, some example implementations operate with respect to the polygonal mesh used in Synthetic 360° scenes, and provide configurations for Forward-Facing and Unbounded 360° scenes. Some example implementations first define a regular grid [symbol] of size P×P×P in the unit cube centered at the origin. Some example implementations instantiate [symbol] by creating one vertex per voxel, and [symbol] by creating one quadrangle (two triangles) per grid edge connecting the vertices of the four adjacent voxels. Some example implementations locally parameterize vertex locations with respect to the voxel centers (and sizes), resulting in [symbol] ∈[−0.5, +0.5]^{P×P×P×3} free variables. During optimization, some example implementations initialize the vertex locations to [symbol] =0, which corresponds to a regular Euclidean lattice, and some example implementations regularize them to prevent vertices from exiting their voxels, and to promote their return to their neutral position whenever the optimization problem is under-constrained:

$${ℒ}_{𝒱} = {\sum }_{v ∈ 𝒱} ( 1 {0}^{3} 𝒥 ( v ) + 1 {0}^{- 2} ) . {‖ v ‖}_{1} , \qquad ( 6 )$$

where the indicator function [symbol] (v)≡1 whenever v is outside its corresponding voxel.

### Example Quadrature

As evaluating the MLPs of some example representations is computationally expensive, some example implementations rely on an acceleration grid to limit the cardinality [symbol] of quadrature points. First of all, quadrature points are only generated for the set of voxels that intersect the ray; Then, some example implementations employ an acceleration grid [symbol] to prune voxels that are unlikely to contain geometry. Finally, some example implementations compute intersections between the ray and the faces of [symbol] that are incident to the voxel's vertex to obtain the final set of quadrature points. Some example implementations use the barycentric interpolation to back-propagate the gradients from the intersection point to the three vertices in the intersected triangle. In summary, in some implementations, for each input ray r:

[symbol]

=intersect(r, [symbol] ) (7)

[symbol]

={b∈ [symbol] | [symbol] [b]> [symbol] } (8)

[symbol]

=intersect(r){t∈ [symbol] t∩B }) (9)

where (a∩b)=true if a intersects b, and the acceleration grid is supervised so to upper-bound the alpha-compositing visibility Tₖαₖ across viewpoints during training.

$${ℒ}_{𝒢}^{bna} = {\sum }_{k} max ( / ∇ [ {T}_{k} {α}_{k} ] - 𝒢 [ {p}_{k} ] , 0 ) \qquad ( 10 )$$

where /∇[·] is the stop-gradient operator that prevents the acceleration grid from (negatively) affecting the image reconstruction quality.

This can be interpreted as a way to compute the so-called “surface field” during NeRF training, as opposed to after training. Some example implementations additionally regularize the content of the grid by promoting its pointwise sparsity (e.g., lasso), and its spatial smoothness:

$${ℒ}_{𝒢}^{sparse} = {‖ 𝒢 ‖}_{1}^{1} {ℒ}_{𝒢}^{smooth} = {‖ ∇ 𝒢 ‖}_{2}^{2} \qquad ( 11 )$$

### Example Binarized Training (Training Stage 2)

Rendering pipelines implemented in typical hardware do not natively support semi-transparent meshes. Rendering semi-transparent meshes requires cumbersome (per-frame) sorting so to execute rendering in back-to-front order to guarantee correct alpha-compositing. Some example implementations overcome this issue by converting the smooth opacity αₖ∈[0,1] from opacity (3) to a discrete/categorical opacity \hat{α}ₖ∈{0,1}. To optimize for discrete opacities via photometric supervision some example implementations employ a straight-through estimator:

\hat{α}ₖ=αₖ+/∇[1(αₖ>0.5)−αₖ] (12)

Note that the gradients are transparently passed through the discretization operation (i.e. ∇\hat{α}≡∇α), regardless of the values of αₖ and the resulting \hat{α}ₖ∈{0,1}. To stabilize training, some example implementations then co-train the continuous and discrete models:

$${ℒ}_{C}^{bin} = {𝔼}_{r} ‖ \hat{C} ( r ) - {C}_{gt} ( r ) {‖}_{2}^{2} \qquad ( 13 )$$

$${ℒ}_{C}^{stage 2} = \frac{1}{2} {ℒ}_{C}^{bin} + \frac{1}{2} {ℒ}_{C} \qquad ( 14 )$$

where Ĉ(r) is the output radiance corresponding to the discrete opacity model \hat{α}:

$$\hat{C} ( r ) = {\sum }_{k = 1}^{K} {\hat{T}}_{k} {\hat{α}}_{k} {c}_{k} , {\hat{T}}_{k} = {\prod }_{l = 1}^{k - 1} ( 1 - {\hat{α}}_{l} ) \qquad ( 15 )$$

Once MSE_plus_binary (14) has converged, some example implementations apply a fine-tuning step to the weights in [symbol] and [symbol] by minimizing while fixing the

$${ℒ}_{C}^{bin} ,$$

while fixing the weights of others.

### Example Discretization (Training Stage 3)

After binarization and fine-tuning, some example implementations convert the representation into an explicit polygonal mesh (e.g., in OBJ format). Some example implementations only store quads if they are at least partially visible in the training camera poses (i.e. non-visible quads are discarded). Some example implementations then create a texture image whose size is proportional to the number of visible quads, and for each quad some example implementations allocate a K×K patch in the texture. Some example implementations use K=17, so that the quad has a 16×16 texture with half-a-pixel boundary padding. Some example implementations then iterate over the pixels of the texture, convert the pixel coordinate to 3D coordinates, and bake the values of the discrete opacity (e.g., opacity (3) and dOpacity (12)) and features (e.g., features (4)) into the texture map. Some example implementations quantize the [0,1] ranges to 8-bit integers, and store the texture into (e.g., losslessly compressed) PNG images. Example experiments show that quantizing the [0,1] range with 8-bit precision, which is not accounted for during backpropagation, does not significantly affect rendering quality.

### Example Anti-Aliasing

In classic rasterization pipelines, aliasing is an issue that ought to be considered to obtain high-quality rendering. While classical NeRF hallucinates smooth edges via semi-transparent volumes, as previously discussed, semi-transparency would require per-frame polygon sorting. Some example implementations overcome this issue by employing anti-aliasing by super-sampling. While it is possible to simply execute (5) four times/pixel and average the resulting color, the execution of the deferred neural shader [symbol] is the computational bottleneck of one example proposed technique. Some example implementations can overcome this issue by simply averaging the features, that is, averaging the input of the deferred neural shader, rather than averaging its output. Some example implementations first rasterize features (at 2×resolution):

$$F ( r ) = {\sum }_{k} {T}_{k} {α}_{k} {f}_{k} , \qquad ( 16 )$$

and then average sub-pixel features to produce the anti-aliased representation some example implementations feed to one example proposed neural deferred shader:

C(r)= [symbol] ( [symbol] ᵣ_{_{δ}}_{~r}[F(r_{δ})], [symbol] ᵣ_{_{δ}}_{~r}[d_{δ}]) (17)

where [symbol] ᵣ_{_{δ}}_{~r} computes the average between the sub-pixels (e.g., four in an example implementation), and d_{δ} is the direction of ray r_{δ}.

Note how with this change some example implementations only query [symbol] once per output pixel. Finally, this process can be analogously applied to (15) for discrete occupancies \hat{α}. These changes for anti-aliasing can be applied in training stage 2 MSE_plus_binary (14).

### Example Rendering

In some implementations, the result of the optimization process is a textured polygonal mesh (where texture maps store features rather than colors) and a small MLP (which converts view direction and features to colors). Rendering this representation is done in two passes using a deferred rendering pipeline:
1. Some example implementations rasterize all faces of the textured mesh with a z-buffer to produce a 2M×2N feature image with 12 channels per pixel, comprising 8 channels of learned features, a binary opacity, and a 3D view direction;
2. Some example implementations synthesize an M×N output RGB image by rendering a textured rectangle that uses the feature image as its texture, with linear filtering to average the features for antialiasing. Some example implementations apply the small MLP for pixels with non-zero alphas to convert features into RGB colors. The small MLP can be implemented as a GLSL fragment shader.

These rendering steps can be implemented within the classic rasterization pipeline. Since z-buffering with binary transparency is order-independent, polygons do not need to be sorted into depth-order for each new view, and thus can be loaded into a buffer in the GPU once at the start of execution. Since the MLP for converting features to colors is very small, it can be implemented in a GLSL fragment shader, which is run in parallel for all pixels. These classical rendering steps are highly-optimized on GPUs, and thus one example proposed rendering system can run at interactive frame rates on a wide variety of devices. It is also easy to implement, since it requires only standard polygon rendering with a fragment shader. One example interactive viewer is an HTML webpage with Javascript, rendered by WebGL via the threejs library.

### Example Devices and Systems

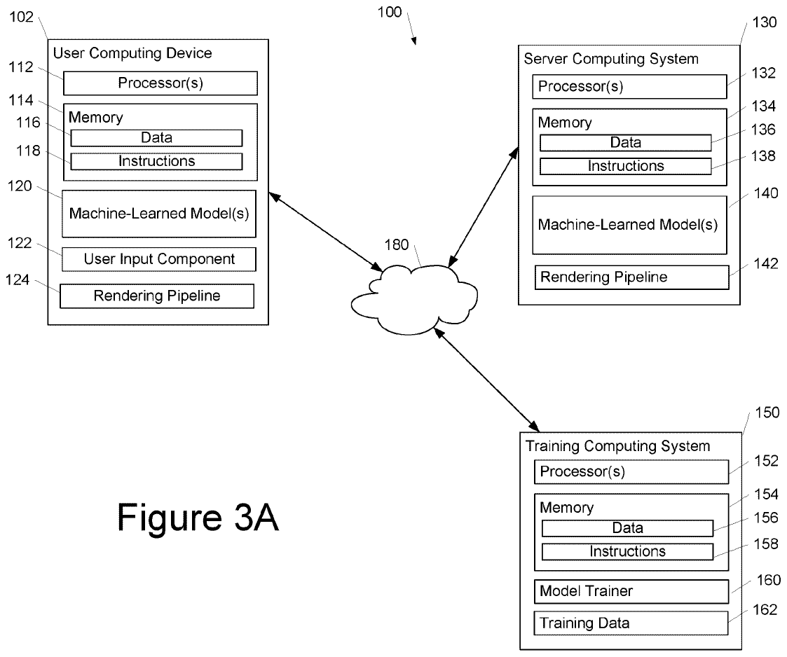

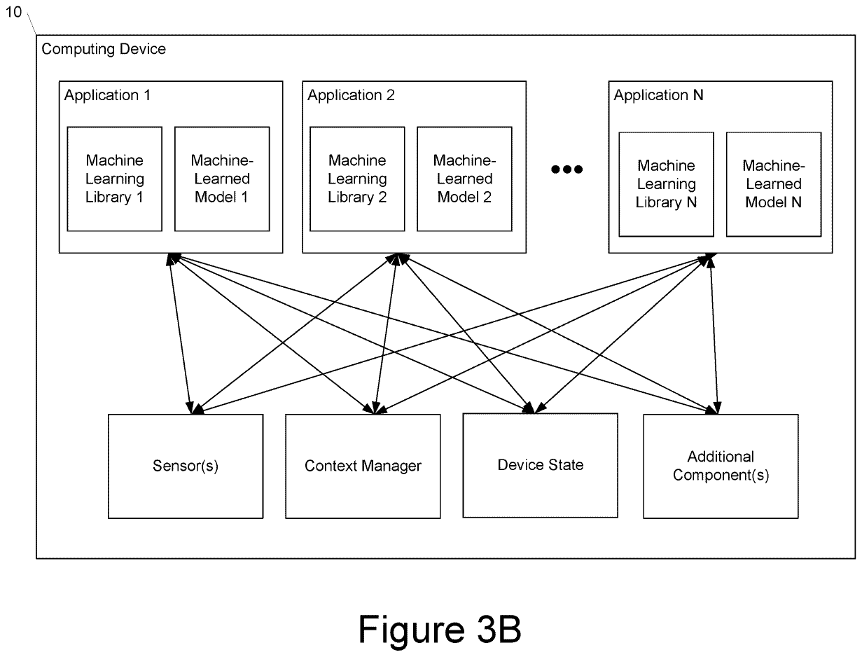

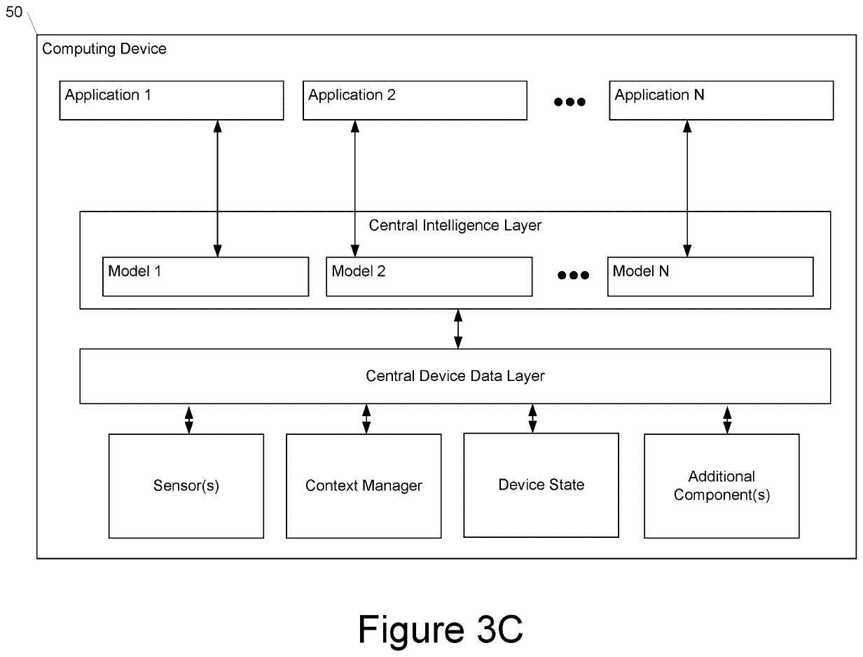

FIG. 3A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel rendering across multiple instances of pixels).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 130 as a portion of a web service (e.g., an image rendering service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The user computing device 102 can also include a rendering pipeline 124. For example, the rendering pipeline 124 can be the pipeline shown or discussed with reference to FIG. 1. The rendering pipeline 124 includes computer logic utilized to provide desired functionality. The rendering pipeline 124 can be implemented in hardware, firmware, and/or software controlling a general purpose processor. For example, in some implementations, the rendering pipeline 124 includes program files stored on a storage device, loaded into a memory and executed by one or more processors. In other implementations, the rendering pipeline 124 includes one or more sets of computer-executable instructions that are stored in a tangible computer-readable storage medium such as RAM, hard disk, or optical or magnetic media.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The server computing system 130 can also include a rendering pipeline 142. For example, the rendering pipeline 142 can be the pipeline shown or discussed with reference to FIG. 1. The rendering pipeline 142 includes computer logic utilized to provide desired functionality. The rendering pipeline 142 can be implemented in hardware, firmware, and/or software controlling a general purpose processor. For example, in some implementations, the rendering pipeline 142 includes program files stored on a storage device, loaded into a memory and executed by one or more processors. In other implementations, the rendering pipeline 142 includes one or more sets of computer-executable instructions that are stored in a tangible computer-readable storage medium such as RAM, hard disk, or optical or magnetic media.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, a plurality of images that depict a scene from known or estimated camera poses.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing device for performing efficient image rendering, the computing device comprising:
one or more processors;
one or more non-transitory computer-readable media that collectively store a mesh model of a scene and one or more texture images comprising learned feature and opacity data for the mesh model; and
a rendering pipeline configured to generate a rendered image of the scene from a specified camera pose, the rendering pipeline comprising:
a mesh rasterizer configured to generate a feature image comprising a plurality of fragments, wherein each fragment corresponds to at least a portion of the mesh model that is visible from the specified camera pose, and wherein, for each fragment, the feature image comprises the respective learned feature and opacity data provided by the one or more texture images for the corresponding portion of the mesh model;
a machine-learned neural fragment shader configured to process the specified camera pose and the respective learned feature and opacity data for each fragment of the feature image to output a respective output color for each fragment for use in the rendered image.

2. The computing device of claim 1, wherein the learned feature and opacity data comprises data that was output by one or more machine-learned neural radiance field models trained on training images that depict the scene.

3. The computing device of claim 2, wherein the machine-learned neural fragment shader was jointly trained with the one or more machine-learned neural radiance field models.

4. The computing device of claim 2, wherein the one or more machine-learned neural radiance field models comprise:
a feature field model configured to process a position to generate feature data for the position; and
an opacity field model configured to process the position to generate opacity data for the position.

5. The computing device of claim 1, wherein the feature image comprises a first resolution, and wherein the rendering pipeline is configured to downsample the feature image to a second, smaller resolution prior to executing the machine-learned neural fragment shader on the feature image.

6. The computer device of claim 1, wherein the mesh model comprises only polygons that are visible from one or more training images of the scene.

7. The computing device of claim 1, wherein the computing device consists of a smartphone, a mobile device, or an embedded device.

8. The computing device of claim 1, wherein the one or more processors comprise one or more graphics processing units, and wherein the mesh rasterizer and the machine-learned neural fragment shader are executed using the one or more graphics processing units.

9. The computing device of claim 1, wherein:
the mesh model is stored as an OBJ file;
the one or more texture images are stored as one or more Portable Network Graphics (PNG) files; and
weights of the machine-learned neural fragment shader are stored in a JavaScript Object Notation (JSON) file.

10. The computing device of claim 1, wherein the rendering pipeline is defined in HyperText Markup Language (HTML).

11. The computing device of claim 1, wherein the neural fragment shader is defined in OpenGL Shading Language (GLSL).

12. A computer-implemented method for generating a rendered image of a scene from a specified camera pose, the method comprising:
obtaining, by a computing system comprising one or more computing devices, a mesh model of the scene and one or more texture images comprising learned feature and opacity data for the mesh model;
generating, by the computing system, a feature image comprising a plurality of fragments, wherein each fragment corresponds to at least a portion of the mesh model that is visible from the specified camera pose, and wherein, for each fragment, the feature image comprises the respective learned feature and opacity data provided by the one or more texture images for the corresponding portion of the mesh model;
processing, by the computing system using a machine-learned neural fragment shader, the specified camera pose and the respective learned feature and opacity data for each fragment of the feature image to output a respective output color for each fragment; and
providing, by the computing system, the rendered image of the scene as an output, the rendered image of the scene having the respective output colors provided by the machine-learned neural fragment shader.

13. The computer-implemented method of claim 12, wherein:
the learned feature and opacity data comprises data that was output by one or more machine-learned neural radiance field models trained on training images that depict the scene; and
the machine-learned neural fragment shader was jointly trained with the one or more machine-learned neural radiance field models.

14. The computer-implemented method of claim 12, wherein:
the feature image comprises a first resolution; and
the method further comprises downsampling, by the computing system, the feature image to a second, smaller resolution prior to processing, by the computing system using the machine-learned neural fragment shader, the specified camera pose and the respective learned feature and opacity data for each fragment of the feature image to output the respective output color for each fragment.

15. One or more non-transitory computer-readable media that collectively store instructions that, when executed by one or more processors, cause the one or more processors to perform operations the operations comprising, for each of one or more training iterations:
obtaining a training image that depicts a scene from a camera pose;
processing a plurality of positions associated with a learnable mesh model with a feature field model to generate feature data and with an opacity field model to generate opacity data;
processing the feature data and the camera pose with a neural fragment shader to generate color data;
performing alpha-compositing of the color data and opacity data based on the camera pose to generate one or more output colors for a rendered image;
evaluating a loss function that compares the rendered image with the training image to determine a loss; and
modifying one or more parameter values for one or more of the following based on the loss: the learnable mesh model, the feature field model, the opacity field model, and the neural fragment shader.

16. The one or more non-transitory computer-readable media of claim 15, further comprising, for at least one of the one or more training iterations:
binarizing the opacity data prior to performing the alpha-compositing.

17. The one or more non-transitory computer-readable media of claim 15, further comprising, for at least one of the one or more training iterations:
subsampling the feature data prior to processing the feature data and the camera pose with the neural fragment shader to generate the color data.

18. The one or more non-transitory computer-readable media of claim 15, further comprising, after the one or more training iterations:
baking the feature data and the opacity data respectively output by the feature field model and the opacity field model into one or more texture images.

19. The one or more non-transitory computer-readable media of claim 15, further comprising, after the one or more training iterations:
pruning portions of the mesh model that are not-visible in any of a plurality of training images of the scene.

20. The one or more non-transitory computer-readable media of claim 15, wherein the learnable mesh model comprises a grid mesh, and wherein modifying one or more parameter values of the learnable mesh model comprises updating vertex locations of the grid mesh while holding a topology of the grid mesh fixed.
